(19) United States
(12) Patent Application Publication
(10) Pub. No.: US 2007/0226225 A1
(43) Pub. Date: Sep. 27, 2007

(54) Mobile collaboration and communication system

(76) Inventors: Timothy Chu-Chak Yiu, Saratoga, CA (US); Wei-Chun Hu, Taipei (TW)

Correspondence Address: RABIN & Berdo, PC, 1101 14TH STREET, NW, SUITE 500, WASHINGTON, DC, 20005, US

(21) Appl. No.: 11/385,868

(22) Filed: Mar. 22, 2006

(51) Int. Cl. G06F 17/30

(52) U.S. Cl. 707/10

(57) ABSTRACT

A mobile collaboration and communication system includes a wireless resource controller for receiving and/or transmitting wireless frequency data; a management module for receiving and/or transmitting data and controlling the operation of the mobile collaboration and communication system; a policy database, connected to the management module, for storing a plurality of levels of authorization for network access; a user account database, connected to the management module, for storing a plurality of authorized user accounts, wherein each user account has a corresponding level of authorization for network access; an access control module, connected to the management module, for controlling access level according the levels of authorization for network access stored in the policy database; and a collaboration and communication module, connected to the management module, for creating and managing a collaboration and communication group for communication, and relaying and controlling the data traffic to and from the electronic devices.

### BACKGROUND

1. Field of the Invention

The invention relates to a collaboration and communication system and, and in particular to a collaboration and communication system having integration and combination of real time collaboration appliance with network controller and wireless data networks.

2. Related Art

WLAN enabled laptop computers and intelligent mobile devices including PDAs and SmartPhones become more prevalent to the business and work environment and will have access to wireless networks whether through WLAN based technologies or through mobile data networks.

For companies who have corporate networks and on which Real Time Collaboration (RTC) applications such as Microsoft's Netmeeting is installed, employees are increasingly using these technologies to conduct meetings or communication. This is accomplished by sharing either their screens or applications or both with other meeting participants in real time. This not only facilitates meeting discussion, but the discussion is memorialized in the documents that are being collaboratively worked on.

While the productivity of intra-company meetings is increasing, this benefit is not being felt in meetings with non-employee guests. In other words, when companies hold meetings with other companies on the premises of one of the companies, the guest attendees typically will not have network access. This is because most of corporate networks are intentionally designed and configured to prevent access by non-employees for security reasons. While it is possible to configure corporate gateway and routers to provision network access for guests, the administrative overhead is high. The return on investment for the Information Technology department is quite low, while more importantly, the security risks are high. The result is that productive collaborative meetings joined by employees cannot be held with visitors such as customers, or vendors.

There are two types of collaboration solutions available: hosted collaboration services and licensed collaboration software. The collaboration solutions usually support the Web conferencing, application sharing and shared whiteboard on an interaction basis. This service has grown in popularity through increased use of time-based and distance-based team collaboration.

The hosted collaboration services provide subscription based services to enable the users to use the services at any place via Internet connection to the sites provided by the service providers. The access is convenient for there is no technical support required from corporate IT department. However, these services have some limitations. For example, prior subscription is required for each attendee to join the meeting so impromptu meeting is not possible when one of the required attendees does not have a subscription. Recurring subscription fees are required to access the service; this is not preferred for cost sensitive businesses. The most serious issue is that meeting materials will be routed through the service operator site that causes concern with respect to the security of proprietary company information.

Licensed collaboration software provides the alternative solution to the hosted collaboration services. The company with a sophisticated information technology (IT) department that is capable of configuring the complicated collaboration software packages can build their own collaboration service environment that provides this type of application to the employees. This insures the security of the company's sensitive information because the meeting materials stay behind the company firewall. Recurring subscription expense for individual employees is not required since the company licenses and operates the solution.

However, licensed collaboration software solution also have limitations. For example, highly skilled IT expertise is required to integrate the licensed collaboration software with complex corporate IT environments, so most businesses will incur heavy IT technical support to configure and maintain the service. Furthermore, corporate IT infrastructure is usually a firewalled environment to insure network security so it is not convenient for collaboration work that involves with external participants such as consultants and visitors.

### SUMMARY

Accordingly, a mobile collaboration and communication system is provided in view of the foregoing problems or limitation.

As embodied and broadly described, the mobile collaboration and communication system includes a wireless resource controller for receiving and/or transmitting wireless frequency data and or other wireless technologies such as Bluetooth, infrared or cellular phone data networks; a management module for receiving and/or transmitting data and controlling the operation of the mobile collaboration and communication system; a policy database, connected to the management module, for storing a plurality of levels of authorization for network access; a user account database, connected to the management module, for storing a plurality of authorized user accounts, wherein each user account has a corresponding level of authorization for network access; an access control module, connected to the management module, for controlling access level according the levels of authorization for network access stored in the policy database; and a collaboration and communication module, connected to the management module, for creating and managing a collaboration and communication group for communication, and relaying and controlling the data traffic to and from the electronic devices.

In another embodiment, as embodied and broadly described, the mobile collaboration and communication system includes a wireless resource controller for receiving and/or transmitting data; a network resource controller for receiving and/or transmitting data; a management module for receiving and/or transmitting data and controlling the operation of the mobile collaboration and communication system; a policy database, connected to the management module, for storing a plurality of levels of authorization for network access; a user account database, connected to the management module, for storing a plurality of authorized user accounts, wherein each user account has a corresponding level of authorization for network access; an access control module, connected to the management module, for controlling access level according the levels of authorization for network access stored in the policy database; and a collaboration and communication module, connected to the management module, for creating and managing a collaboration and communication group for communication, and relaying and controlling the data traffic to and from the electronic devices.

According to the embodiments, user account management allows visitors to access the application and external network resource without compromising the internal network security.

According to the embodiments, impromptu meeting via flexible account generation and management scheme is feasible.

According to the embodiments, built-in collaboration application enables the Web conferencing, application sharing and shared whiteboard on an interaction basis.

According to the embodiments, the shared materials are not routed to through external network for information security.

According to the embodiments, multiple independent collaboration sessions simultaneously are feasible to enable multiple teams to work independently.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

### BRIEF DESCRIPTION OF THE DRAWINGS

The above and other objects, features and other advantages of the invention will be more clearly understood from the following detailed description when taken in conjunction with the accompanying drawings, in which:

FIG. 1 illustrates the hardware configuration of the collaboration and communication system in accordance with the invention.

FIG. 2 illustrates the schematic block diagram of the collaboration and communication system in a collaboration group.

FIG. 3 illustrates the application of the collaboration and communication system in a collaboration and communication group.

FIG. 4 illustrates another application of the collaboration and communication system in a collaboration and communication group.

FIG. 5 illustrates another application of the collaboration and communication system in a collaboration and communication group.

FIG. 6 illustrates the types of the participants in a collaboration and communication group of the collaboration and communication system.

FIG. 7 illustrates the login process in accordance with the embodiment.

FIG. 8 illustrates the C&C group creation process in accordance with the embodiment.

### DETAILED DESCRIPTION

Reference will now be made in greater detail to an embodiment of the invention, an example of which is illustrated in the accompanying drawings. Wherever possible, the same reference numerals are used throughout the drawings and the description to refer to the same or like parts.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

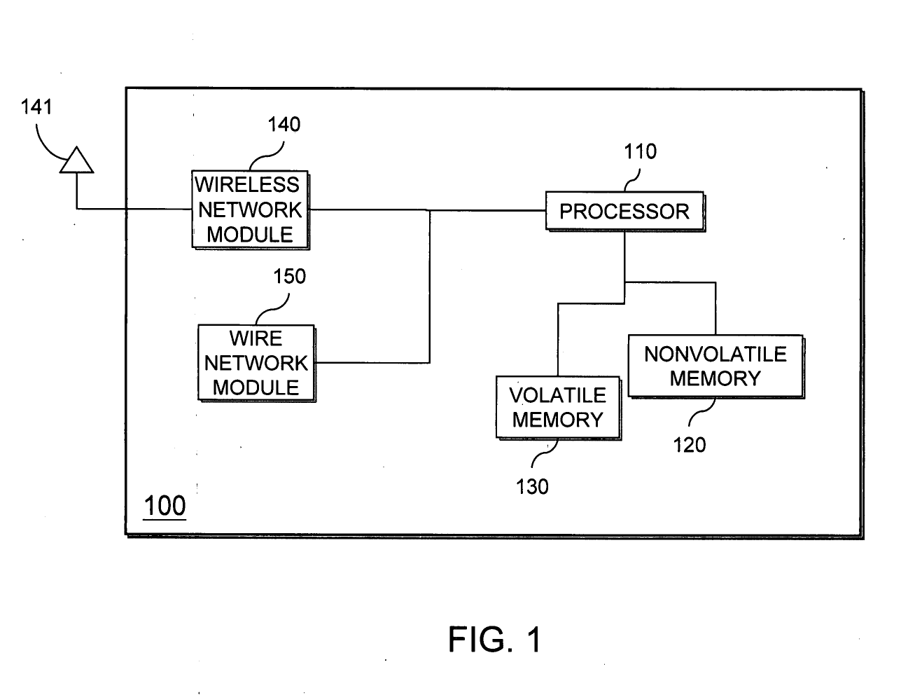

Refer to FIG. 1 illustrating the hardware block diagram of the collaboration and communication system. A processor 110 controlling the operation of the collaboration and communication system is included in the hardware 100. A nonvolatile memory 120 and a volatile memory 130 are also provided for the auxiliary operation of the processor 110. The nonvolatile memory 120 stores the collaboration client program.

In one embodiment, the hardware may be served as a wireless device. In this situation, a wireless network module 140 for transmitting and/or receiving wireless data signals is provided. The collaboration and communication system 100 is equipped with an antenna 141 and works as a wireless AP as well. The wireless network module 140 may be a module compliant with IEEE 802.11 WLAN (i.e. 802.11a, 802.11b, 802.11 g, 802.11n), 802.16 WiMax (i.e. 802.16-2004 and 802.16e), 802.15 ZigBee, or Bluetooth standard or infrared or cellular phone data networks (2G-GSM, 2G-CDMA, 3G-WCDMA, 3G-CDMA-2000), Ultra-Wide Band or any other wireless data standards that might evolve.

In another embodiment, a wire network module 150 is also provided in the hardware. Besides, a plurality of network connection ports is provided together with the wire network module 150 such that the hardware 100 may connect to the Internet or intranet.

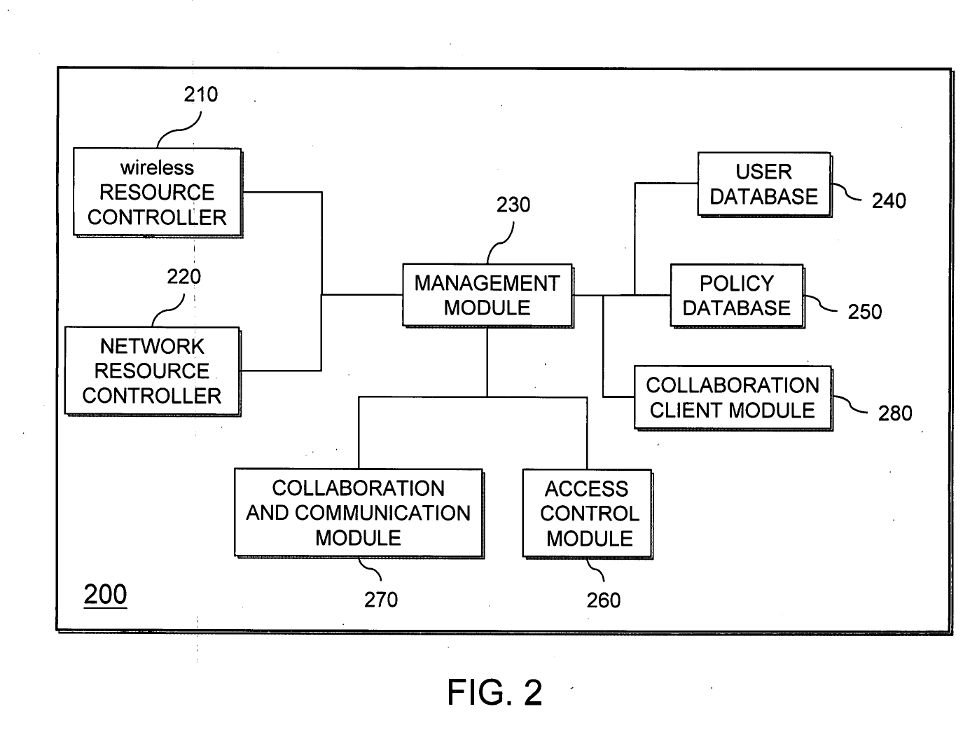

Refer to FIG. 2 illustrating the block diagram of the collaboration and communication system 200, for example, may serve as a wireless service gateway, which is capable of user account management, bandwidth control and many other gateway functions. When the collaboration and communication system 200 is connected to Internet no matter by wired or wireless way, authorized users are allowed to access internet.

The collaboration and communication system 200 allows authorized users to host or join a communication group, name of all attendees who will appear on the panel during in a communication group. Through the collaboration and communication system 200, the meeting host can interact with attendees by sharing his desktop. Therefore, what shows on the host's desktop will simultaneously be shown on all of the attendees' display.

The collaboration and communication system 200 includes a wireless resource controller 210 for receiving and/or transmitting wireless data. The wireless resource controller 210 is compliant with IEEE 802.11 WLAN (i.e. 802.11a, 802.11b, 802.11 g, 802.11n), 802.16 WiMax (i.e. 802.16-2004 and 802.16e), 802.15 ZigBee, or Bluetooth standard or infrared or cellular phone data networks (2G-GSM, 2G-CDMA, 3G-WCDMA, 3G-CDMA-2000), Ultra-Wide Band or cellular phone data networks or any other wireless data standards that might evolve. A wired network resource controller 220 is also provided for receiving and/or transmitting data. The network resource controller 220 is compliant with TCP/IP standard. The wireless resource controller 210 is provided for wireless data communication, while the network resource controller 220 is provided for wired data communication.

The management module 230 controls the operation of the collaboration and communication system 200. The management module 230 connects to a user account database 240, a policy database 250, an access control module 260 and a collaboration module 270, all of which are illustrated in details in the following paragraph.

The user account database 240 included in the collaboration and communication system 200 stores a plurality of authorized accounts which may log into the collaboration and communication system 200. A password associated with the authorized user account is also stored in the user account database 240. The authorized user accounts enable a mobile device having thereof to register or log in to the collaboration and communication system 200.

The policy database 250 controlled by the management module 230 stores a plurality of levels of authorization based on the company policies. Each authorized user account in the user account database 240 and visitor account has a corresponding level of authorization. Each account has different level of authority. In one embodiment, the user account with the highest level of authorization may connect to Internet or intranet. The user account with the lowest level of authorization may only connect to system and can't connect to Internet or intranet through the system.

Through the user account database 240 and the policy database 250, a host may create a temporary account for guest or visitors. Therefore, guests would be provisioned access to this application-specific overlay network by authorized users (acting as hosts for visitors) who in turn would be given varying levels of authorization abilities based on policy database 250. This allows visitors to access the application and external network resource without comprising the internal network security.

An access control module 260 controlled by the management module 230 is provided. When the system detects a mobile device within a radio frequency coverage or a device is connected to the system, the access control module 260 controls if the device may log into the system or not. Even though a user logs into the system, the access control module 260 may further detect the level of authorization to access the network. If the user has the level of authority, he/she may access the network, or only join the collaboration and communication group.

The collaboration and communication module 260 (refer to C&C module in the following paragraphs) connected to the management module 230 operates to create and manage a collaboration and communication group for the host and the attendees to have a meeting or data communication. The collaboration and communication module 260 also relay and control the data among the mobile devices.

In one embodiment, a collaboration client module 280 is also provided, which is also controlled by the management module 230. A client program for collaboration and communication is stored in the collaboration client module 280. When a mobile device first connects to the system, the management module 230 detects if the client program exists or not. If not, the client program stored in the collaboration client module 280 is automatically delivered to the mobile device from the collaboration client module 280 under control of the management module 230.

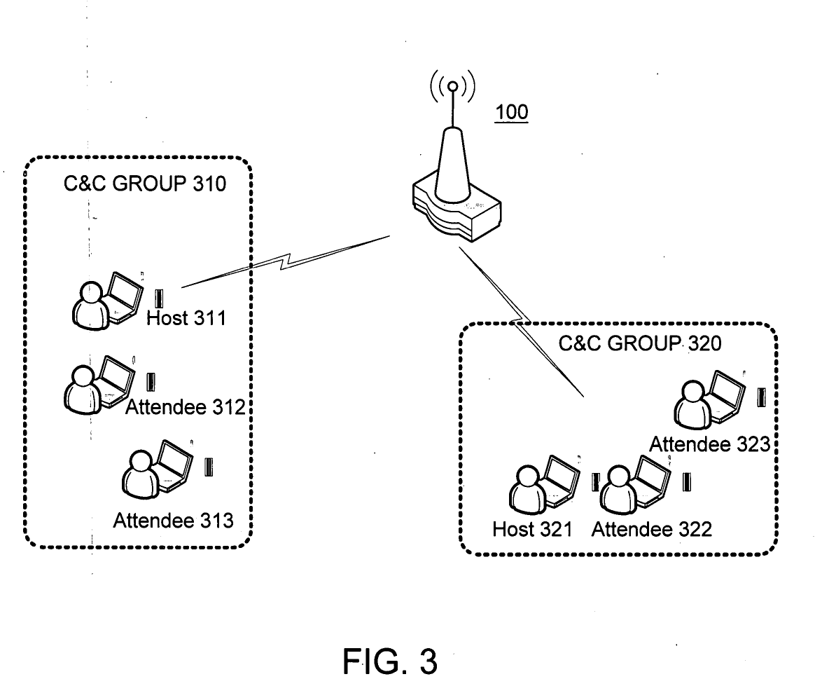

Refer to FIG. 3 illustrating the application of the mobile collaboration and communication system in accordance with the invention.

In this embodiment, the collaboration and communication system 200 operates in an external network independent environment. It is understood that a plurality of collaboration and communication group (refer to C&C group in the following paragraphs) may be created through the client program stored in the mobile device, for example C&C group 310, 320. Many participants with different levels of control authority may join a created C&C group. The levels of control authority will be given in details in the following.

In each C&C group, a participant who creates the group must exist. The user who creates the group is defined as “host” in the embodiment. In C&C group 310, at least one host 311 exists. The host 311 has the authority to create a C&C group and control the data communication in the C&C group. Two attendees 312 and 313 also join the C&C group 310. The attendees 312 and 313 have different level authority from that of the host 311. The embodiment illustrates the C&C group 310, 320 may be created at the same time.

In the embodiment of FIG. 3, the C&C system 200 only servers for communication. The users may communicate with each other through the system. However, the users can't access Internet or intranet through the system.

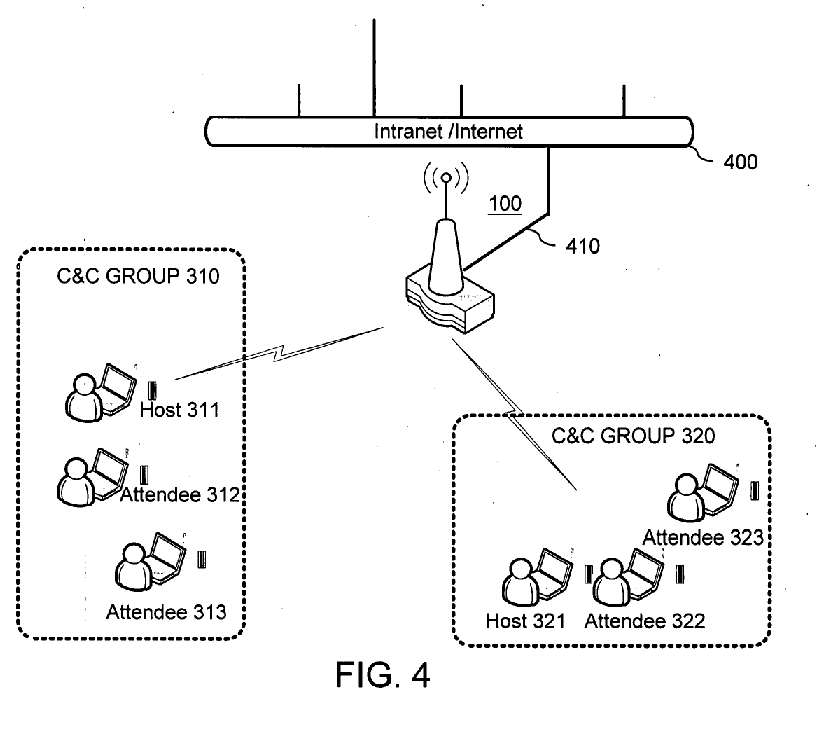

Refer to FIG. 4 illustrating another application of the mobile collaboration and communication system in accordance with the invention. In this embodiment, the collaboration and communication system 200 operates in an external network dependent environment. In this embodiment, the C&C system 200 connects to an intranet or Internet 400 by wired means such that the mobile device may connect to the intranet or Internet through the C&C system 200. Although the C&C system 200 connects to Internet 400 by wired means 410, the C&C system 200 may also connect to Internet 400 by wireless means.

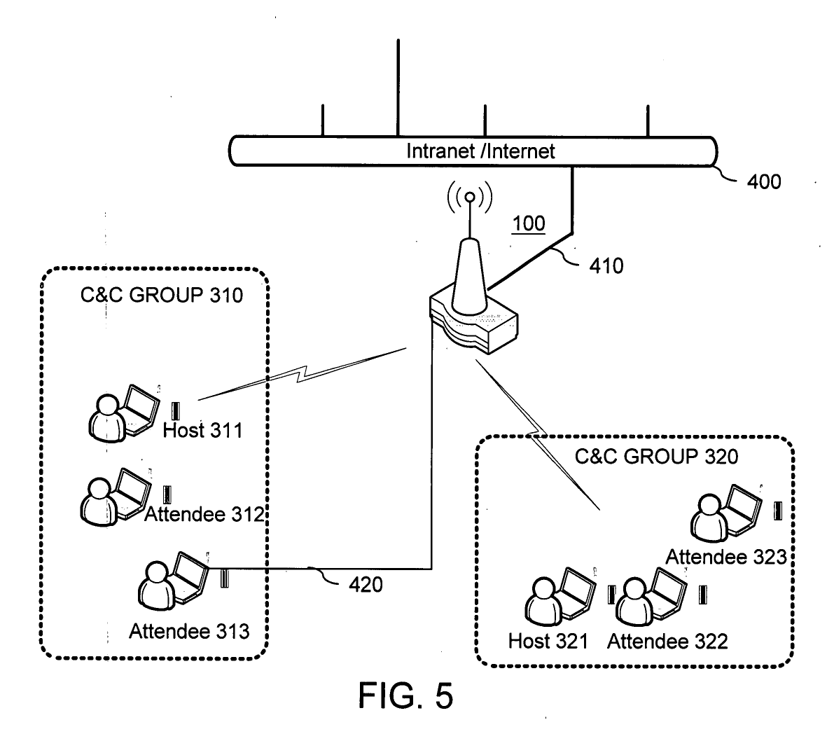

Refer to FIG. 5 illustrating another application of the mobile collaboration and communication system in accordance with the invention. This embodiment is very similar to the embodiment in FIG. 4 except that one mobile device connects to the C&C system 200 by wired means 420.

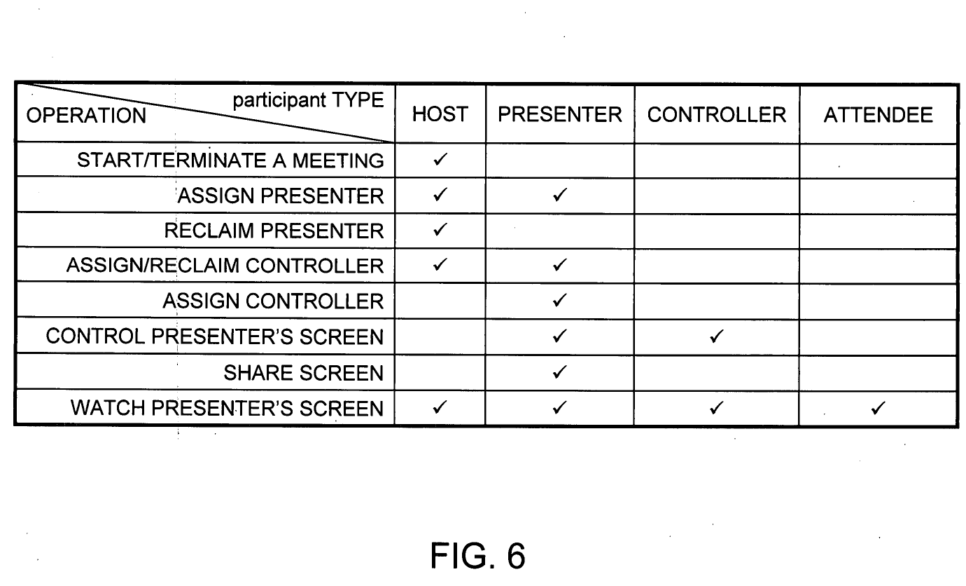

Refer to FIG. 6 illustrating the types of the various participants. In this embodiment, four types of meeting participants are defined, which are host, presenter, controller and attendee. When a C&C group is created, there are six operations that may be executed by different participants in this embodiment. The six operations are start/termination of a meeting, assignment/reclaim of presenter status, assignment/reclaim of controller status, control presenter's screen, share screen with other participants, and watch presenter's screen. By default, the host is the presenter and controller when communication begins in the C&C group. Both controller and presenter can control the presenter's desktop at the same time. Only one presenter is allowed in a meeting.

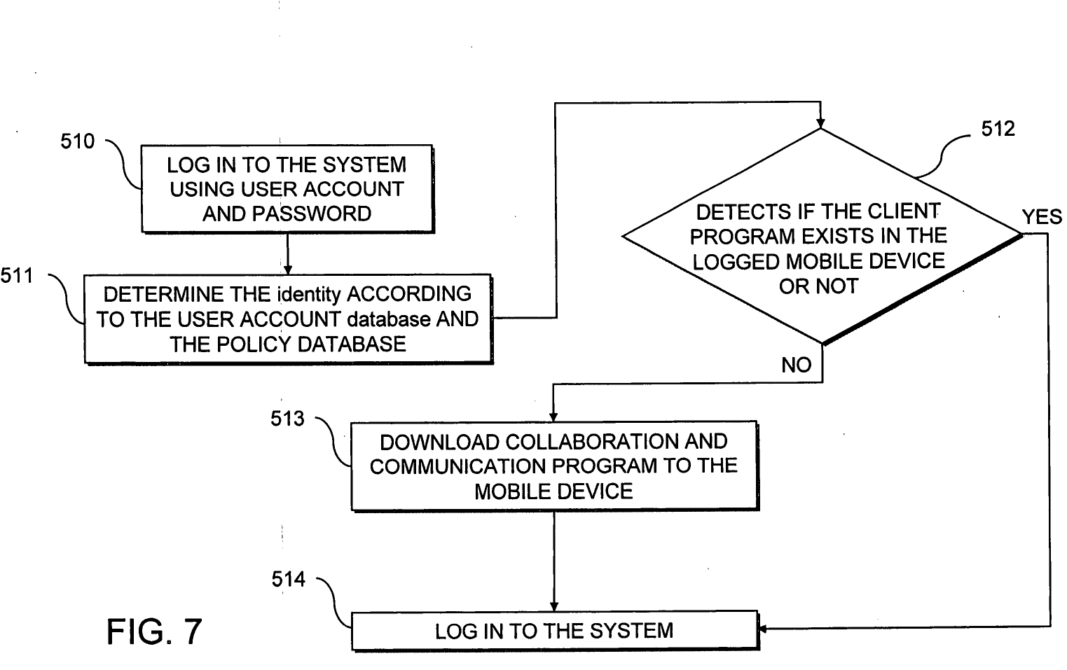

Refer to FIG. 7 illustrating the login process in accordance with the embodiment. When a mobile device with a wireless access module detects existing of the collaboration system 200, the collaboration system 200 delivers authorizations to the mobile device to register into the system. The mobile device, for example, may be a notebook, cellular phone, PDA, and etc.

A mobile device having an authorized account may register into the mobile collaboration system 200 in the beginning and creating a meeting room. In the beginning, the user may log into the system 200 by using a user account and a related password when the mobile device may communicate with the C&C system 200 (step 510). Then the management module 230 determines the identity according to the user account database and the policy database (step 511). The management module 230 then detects if the client program exists in the logged mobile device or not (step 512). If the program does not exist, the client program is automatically delivered to the mobile device through the collaboration client module 230 under control of the management module 230 (step 513). If the program already exists in the system, the mobile system logs into the system successfully (step 514). The steps 510 to 514 are executed for every mobile device that communicate with the system in the beginning.

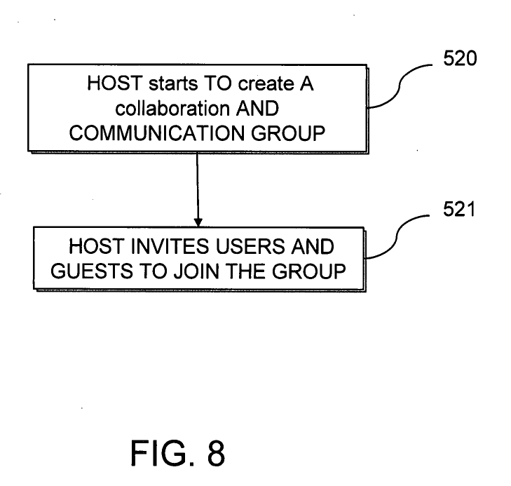

Refer to FIG. 8 illustrating the C&C group creation process in accordance with the embodiment. When a user logs in the system as a host, the user may create a C&C group. The host first creates a C&C group (step 520). The host may name a topic for the group, and then invite the users that have logged into the system to participate the created group (step 521). If a guest having not an user account stored in the user account database, the host may create a temporary user account for the guest to participate the created group (step 521).

When a host creates a C&C group, any user who logs in to the system may join the created C&C group. An attendee who has an authorized account may join the created C&C group. Any attendee may quit the C&C group or participate the C&C group again.

According the provided system, guests could be provided temporary and task specific access to this specialized network. The guest access would be automatically removed upon completion of the task or by a specified amount of time which can be set by a host employee or by policy or by the earlier of the two previous conditions. The collaboration client module would facilitate the easy download and installation of a software client to attached devices.

In the most basic case, the appliance can be installed in a standalone mode where it is not connected to another network. This appliance includes a wireless access point which provides a wireless network that is specific to the purpose of enabling real time communication capabilities among meeting attendees. In the simplest configuration of the appliance, all users who access the local network would have the same status and may start/host and join meetings without additional authorization.

For enhanced network security, the appliance can be configured to mange user policies to allow the host organization to specify different authorization levels and this information would be securely maintained locally within this appliance. In other words, the controller within the appliance can specify different levels of access and authorization. For example, an employee could host and attend meetings, but a guest can only attend a meeting.

This appliance can be deployed inside company conference rooms to facilitate higher productivity meetings amongst employees with or without their guests who might be customers, vendors and or contractors. Or it could be deployed in a hospitality environment such as internet cafes, hotels and convention centers which serves business travelers who might wish to meet. Or this standalone deployment could be installed in universities and schools to facilitate collaboration by teachers and students and amongst students.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A mobile collaboration and communication system for communicating among a plurality of electronic devices, comprising:
a wireless resource controller for receiving and/or transmitting wireless frequency data;
a management module for receiving and/or transmitting data and controlling the operation of the mobile collaboration and communication system;
a policy database, connected to the management module, for storing a plurality of levels of authorization for network access;
a user account database, connected to the management module, for storing a plurality of authorized user accounts, wherein each user account has a corresponding level of authorization for network access;
an access control module, connected to the management module, for controlling access level according the levels of authorization for network access stored in the policy database; and
a collaboration and communication module, connected to the management module, for creating and managing a collaboration and communication group for communication, and relaying and controlling the data traffic to and from the electronic devices.

2. The system of claim 1, further comprising a collaboration client module, connected to the management module, for storing a collaboration client program which is downloaded to the electronics devices.

3. The system of claim 1, wherein each of the plurality of authorized user accounts has a corresponding password.

4. The system of claim 1, wherein the wireless resource controller is compliant with IEEE 802.11, 802.16, 802.15, Bluetooth standard, infrared, Ultra-Wide Band or cellular phone data networks.

5. A mobile collaboration and communication system for communicating among a plurality of electronic devices, comprising:
a wireless resource controller for receiving and/or transmitting wireless frequency data;
a wired network resource controller for receiving and/or transmitting data;
a management module for receiving and/or transmitting data and controlling the operation of the mobile collaboration and communication system;
a policy database, connected to the management module, for storing a plurality of levels of authorization for network access;
a user account database, connected to the management module, for storing a plurality of authorized user accounts, wherein each user account has a corresponding level of authorization for network access;
an access control module, connected to the management module, for controlling access level according the levels of authorization for network access stored in the policy database; and
a collaboration and communication module, connected to the management module, for creating and managing a collaboration and communication group for communication, and relaying and controlling the data traffic to and from the electronic devices.

6. The system of claim 5 further comprising a collaboration client module, connected to the management module, for storing a collaboration client program which is downloaded to the electronics devices.

7. The system of claim 5, wherein each of the plurality of authorized user accounts has a corresponding password.

8. The system of claim 5, wherein the wireless resource controller is compliant with IEEE 802.11, 802.16, 802.15, Bluetooth standard, infrared, Ultra-Wide Band or cellular phone data networks.

9. A mobile collaboration and communication system for communicating among a plurality of electronic devices, comprising:
a wireless network module for receiving and/or transmitting wireless frequency data;
a nonvolatile memory for storing:
a policy database, connected to the management module, for storing a plurality of levels of authorization for network access;
a user account database, connected to the management module, for storing a plurality of authorized user accounts, wherein each user account has a corresponding level of authorization for network access;
an access control module, connected to the management module, for controlling access level according the levels of authorization for network access stored in the policy database; and
a collaboration and communication module, connected to the management module, for creating and managing a collaboration and communication group for communication, and relaying and controlling the data traffic to and from the electronic devices.
a processor for executing a management module for receiving and/or transmitting data and controlling the operation of the mobile collaboration and communication system; and
a volatile memory communicating with the process for auxiliary operation of the processor.

10. The system of claim 9, further comprising a collaboration client module, connected to the management module, for storing a collaboration client program which is downloaded to the electronics devices.

11. The system of claim 9, wherein each of the plurality of authorized user accounts has a corresponding password.

12. The system of claim 9, wherein the wireless resource controller is compliant with IEEE 802.11, 802.16, 802.15, Bluetooth standard, infrared, Ultra-Wide Band or cellular phone data networks.

13. A mobile collaboration and communication system for communicating among a plurality of electronic devices, comprising:
a wireless network module for receiving and/or transmitting wireless frequency data;
a wired network module for receiving and/or transmitting data;
a nonvolatile memory for storing:
a policy database, connected to the management module, for storing a plurality of levels of authorization for network access;
a user account database, connected to the management module, for storing a plurality of authorized user accounts, wherein each user account has a corresponding level of authorization for network access;
an access control module, connected to the management module, for controlling access level according the levels of authorization for network access stored in the policy database; and
a collaboration and communication module, connected to the management module, for creating and managing a collaboration and communication group for communication, and relaying and controlling the data traffic to and from the electronic devices.
a processor for executing a management module for receiving and/or transmitting data and controlling the operation of the mobile collaboration and communication system; and
a volatile memory communicating with the process for auxiliary operation of the processor.

14. The system of claim 13, further comprising a collaboration client module, connected to the management module, for storing a collaboration client program which is downloaded to the electronics devices.

15. The system of claim 13, wherein each of the plurality of authorized user accounts has a corresponding password.

16. The system of claim 13, wherein the wireless resource controller is compliant with IEEE 802.11, 802.16, 802.15, Bluetooth standard, infrared, Ultra-Wide Band or cellular phone data networks.
